(19) United States
(12) Patent Application Publication
(10) Pub. No.: US 2012/0243794 A1
(43) Pub. Date: Sep. 27, 2012

(54) IMAGE PROCESSING APPARATUS, IMAGE ENCODING SYSTEM AND IMAGE DECODING SYSTEM

(75) Inventor: Milosz Gabriel Sroka Chalot, Yokohama-Shi (JP)

(73) Assignee: KABUSHIKI KAISHA TOSHIBA, Tokyo (JP)

(21) Appl. No.: 13/233,239

(22) Filed: Sep. 15, 2011

(30) Foreign Application Priority Data
Mar. 25, 2011 (JP) 2011-067391

(51) Int. Cl. G06K 9/46

(52) U.S. Cl. 382/201

(57) ABSTRACT

According to one embodiment, an image processing apparatus includes a feature based detector, an optimum area generator, and an output data generator. The feature based detector detects a feature portion of input image data and generates feature area information showing a position of a feature area comprising the detected feature portion. The optimum area generator generates optimum area information showing a position of an optimum area in accordance with a size of the feature area based on the feature area information. The output data generator extracts pixels of the optimum area among the input image data based on the optimum area information and generates output image data based on the extracted pixels.

CROSS REFERENCE TO RELATED APPLICATION(S)

This application is based upon and claims the benefit of priority from the prior Japanese Patent Application No. 2011-67391, filed on Mar. 25, 2011, the entire contents of which are incorporated herein by reference.

### FIELD

Embodiments described herein relate generally to an image processing apparatus, an image encoding system, and an image decoding system.

### BACKGROUND

In a conventional image processing apparatus, an arbitrary point corresponding to a feature portion of image data representing a still image is detected as a feature point, image data representing an image in which the detected feature point is located at the center thereof generated in accordance with a magnification specified by a user, and image data representing the feature portion is generated on the basis of the generated image data.

In the conventional image processing apparatus, since image data is generated in accordance with an instruction of a user (for example, a specified area and a specified magnification), the image data representing the feature portion cannot be generated if there is no instruction from the user. Further, in the conventional image processing apparatus, since only one point of the image data representing a still image is detected, such an apparatus is not suitable for image data representing a moving image, which is constituted by a plurality of frames.

### BRIEF DESCRIPTION OF THE DRAWINGS

FIG. 1 is a block diagram of an image encoding system 1 of the present embodiment.

FIG. 2 is a block diagram of the image processing apparatus 10 of the present embodiment.

FIG. 3 is a flow chart of the image processing of the present embodiment.

FIG. 4 is a diagram for explaining one example of the feature area information of the present embodiment.

FIG. 5 is an explanatory diagram of the data structure of the feature area information of the present embodiment.

FIG. 6 is an explanatory diagram of the optimum area information of the present embodiment.

FIG. 7 is a block diagram of the frame controller 16 of the first embodiment.

FIG. 8 is a flow chart of the frame control of the first embodiment.

FIGS. 9A to 9C show explanatory diagrams of the frame control of the first embodiment.

FIG. 10 is a block diagram of the frame controller 16 of the second embodiment.

FIG. 11 is a flow chart of the frame control of the second embodiment.

FIG. 12 is an explanatory diagram of the data structure of the target area information of the second embodiment.

FIGS. 13A and 13B are schematic views of the target area T and an inner reference area RI of the second embodiment.

FIGS. 14A and 14B are schematic views of the target area T and an outer reference area Ro of the second embodiment.

FIGS. 15 and 16A to 16D are explanatory diagrams of the optimum area B of the second embodiment.

FIG. 17 is a flow chart of the optimum area movement of the second embodiment.

FIG. 18 is a block diagram of the image decoding system 2 of the present embodiment.

### DETAILED DESCRIPTION

Embodiments will now be explained with reference to the accompanying drawings.

In general, according to one embodiment, an image processing apparatus includes a feature based detector, an optimum area generator, and an output data generator. The feature based detector detects a feature portion of input image data and generates feature area information showing a position of a feature area comprising the detected feature portion. The optimum area generator generates optimum area information showing a position of an optimum area in accordance with a size of the feature area based on the feature area information. The output data generator extracts pixels of the optimum area among the input image data based on the optimum area information and generates output image data based on the extracted pixels.

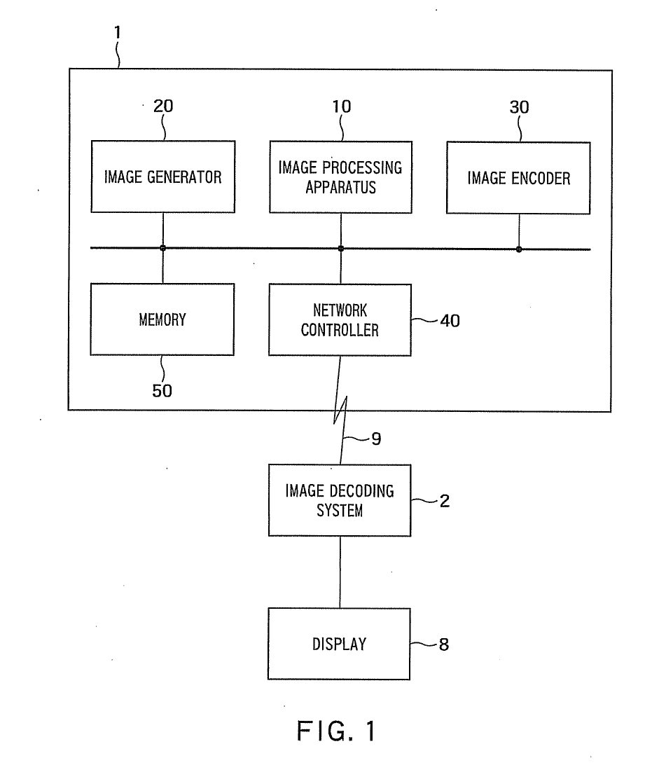

The constitution of the image processing system of the present embodiment will now be described. FIG. 1 is a block diagram of an image encoding system 1 of the present embodiment. The image encoding system 1 is an image processing system including an image processing apparatus 10, an image generator 20, an image encoder 30, a network controller 40, and a memory 50. The image generator 20 takes original image such as a still image or a moving image, and then generates image data representing the taken original image. The image data includes one piece of frame data in the case that the original image is the still image. On the other hand, the image data includes a plurality of pieces of frame data in the case that the original image is a moving image. The image generator 20 is, for example, a camera module. The image processing apparatus 10 performs image processing on an input stream including at least one piece of frame data, and then generates an output stream. The image encoder 30 encodes the output stream, and then generates encoding data. The network controller 40 transmits the encoding data generated by the image encoder 30 to an image decoding system 2 via a network 9. The memory 50 stores various pieces of data necessary for image processing. The memory 50 is, for example, Dynamic Random Access Memory (DRAM). The network 9 is, for example, Internet. The encoding data is decoded by the image decoding system 2, and then is displayed on a display 8.

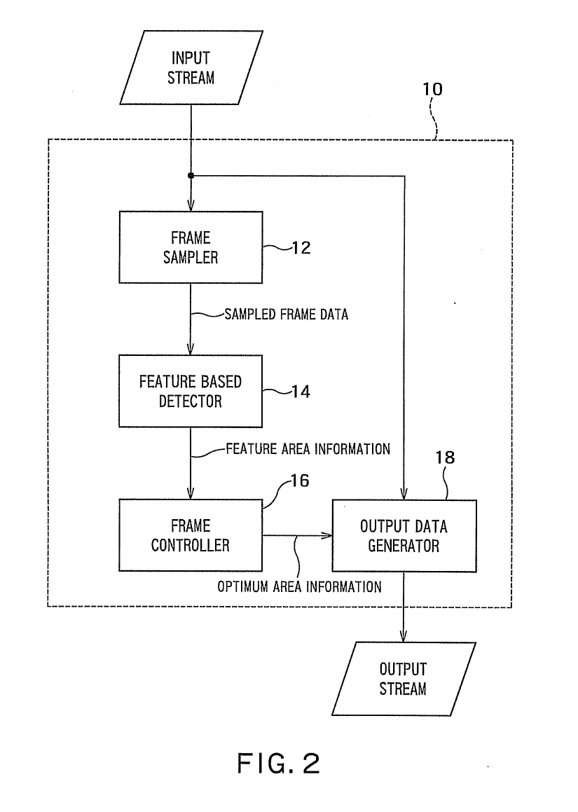

The constitution of the image processing apparatus 10 of the present embodiment will now be described. FIG. 2 is a block diagram of the image processing apparatus 10 of the present embodiment. The image processing apparatus 10 includes a frame sampler 12, a feature based detector 14, a frame controller 16, and an output data generator 18. The frame sampler 12 samples the input stream. The feature based detector 14 generates feature area information based on the sampled frame data. The feature area information is information showing a position on the frame data of a feature area including a feature portion of the original image. The frame controller 16 generates optimum area information based on the feature area information. The optimum area information is information showing a position on the frame data of an optimum area in accordance with the size of the feature area. The output data generator 18 generates the output stream based on the input stream and the optimum data information. The output stream includes image data of the optimum area among the frame data of the image stream. The frame sampler 12 can be omitted. In this case, the feature based detector 14 generates the feature area information based on the frame data of the input stream.

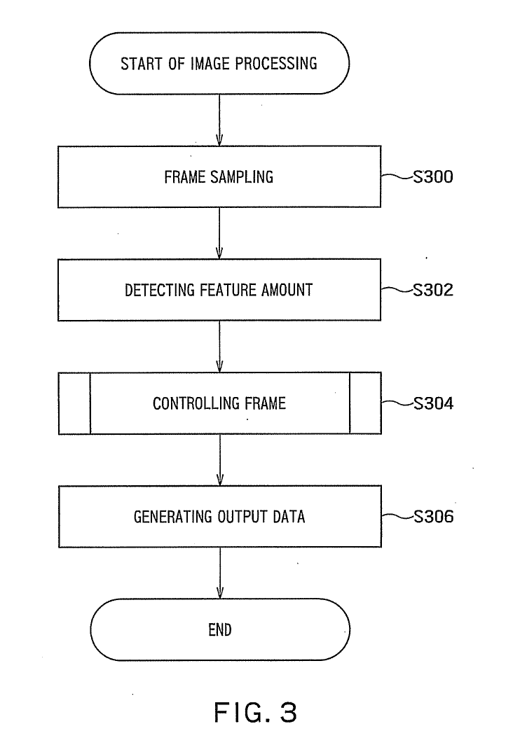

The operation of the image processing apparatus 10 of the present embodiment will now be described. FIG. 3 is a flow chart of the image processing of the present embodiment.

<S300> The frame sampler 12 samples the input stream which is inputted at a predetermined input frame rate (for example, 30 fps) at a predetermined sampling frame rate (for example, 2 fps). Thereby, the frame data inputted to the feature based detector 14 is reduced. As a result, the processing amount of the feature based detector 14 and the frame controller 16 can be reduced.

<S302> The feature based detector 14 detects a feature portion of an image of the sampled frame data by using a predetermined analysis method, and then generates the feature area information. The feature area information is stored in the memory 50. The analysis method is, for example, Co-occurrence Histograms of Oriented Gradients (CoHOG). The feature area information demarcates a rectangular area corresponding to the feature area on the frame data.

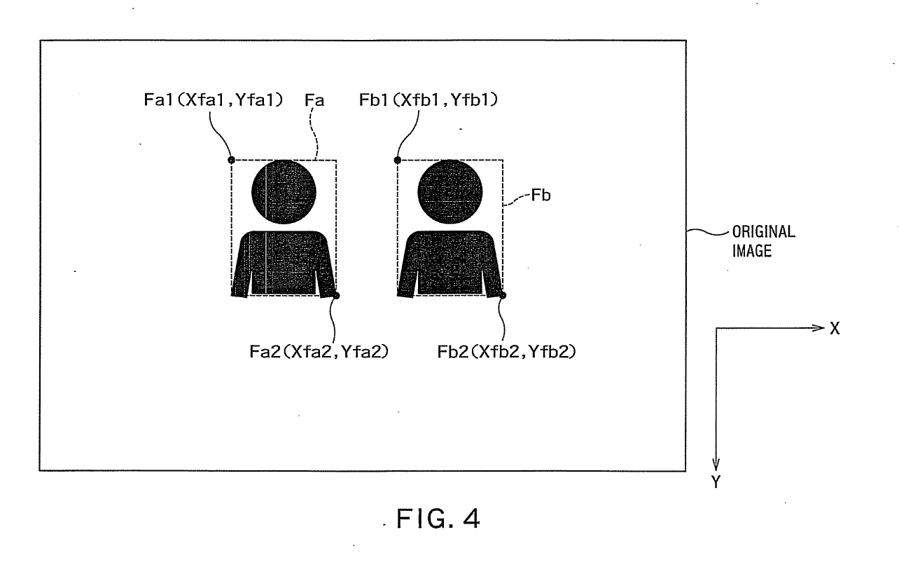

FIG. 4 is a diagram for explaining one example of the feature area information of the present embodiment. In FIG. 4, a case in which two people are on the same screen is shown. The feature portion is the upper bodies (bust up) of the two people, and the feature areas Fa and Fb are each rectangular areas surrounding the upper body of one person. In other words, the number of feature areas F is equivalent to the number of people included in the original image.

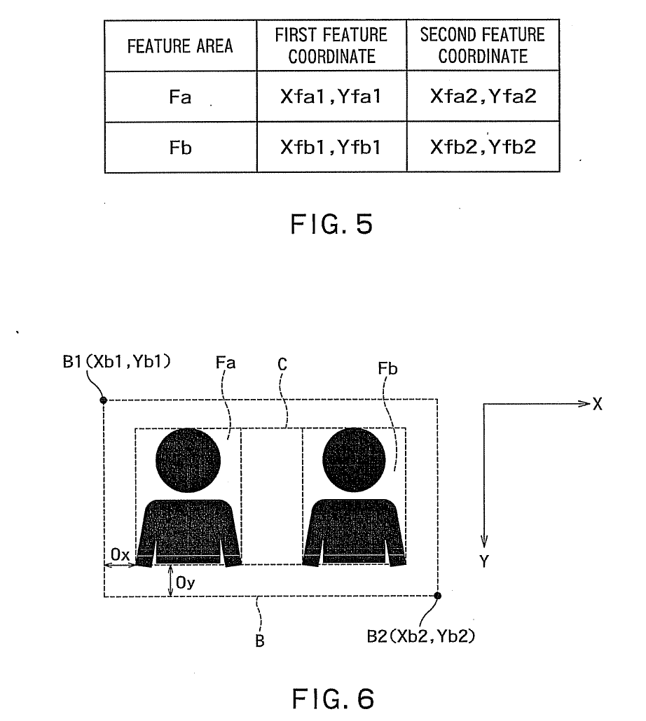

FIG. 5 is an explanatory diagram of the data structure of the feature area information of the present embodiment. The feature area information includes a first feature coordinate (Xfa1, Yfa1) of a first feature end F1 positioned on an arbitrary corner of the feature area F, and a second feature coordinate (Xfa2, Yfa2) of a second feature end F2 positioned on an opposite corner with regard to the first feature end F1. Thereby, the rectangular area can be specified.

<S304> The frame controller 16 generates the optimum area information based on the feature area information. The optimum area information is stored in the memory 50. For example, if the input frame rate is 30 fps and the sampling frame rate is 2 fps, the frame controller 16 generates 30 pieces of optimum area information from two pieces of feature area information per second.

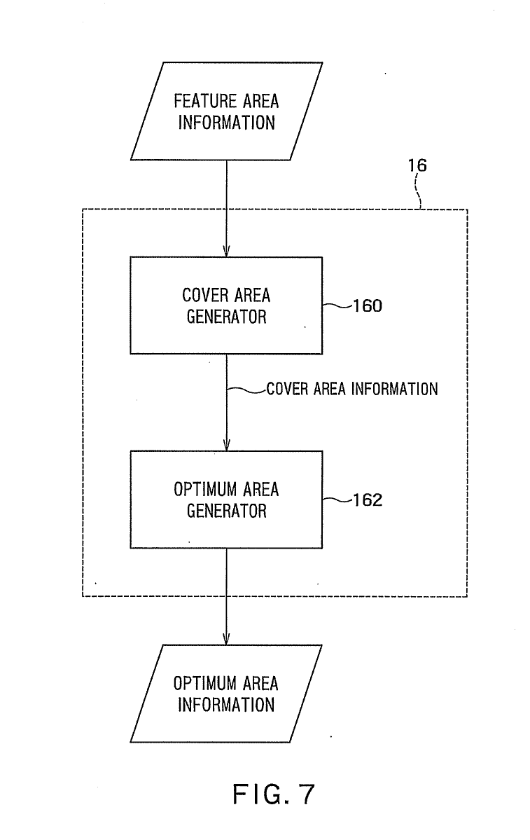

An optimum area B is a rectangular area including a cover area C including all of the feature areas F, and an offset area defined by a first offset Ox in the X direction and a second offset Oy in the Y direction. The optimum area information includes a first optimum coordinate (Xb1, Yb1) of a first optimum end B1 positioned on an arbitrary corner of the optimum area B, and a second optimum coordinate (Xb2, Yb2) of a second optimum end B2 positioned on an opposite corner with regard to the first optimum end B1. In other words, the position and size of the optimum area B depends on those of the feature area F. FIG. 6 is an explanatory diagram of the optimum area information of the present embodiment.

<S306> The output data generator 18 generates an output stream by using the input stream and the optimum area information of the memory 50. In more detail, regarding the plurality of frame data of the input stream, the output data generator 18 resizes the extracted pixels of the optimum area B shown by the optimum area information into a size in accordance with the resolution, and then generates output image data. The resolution is information provided in advance, and corresponds to, for example, the resolution of the display 8. The output image data is stored in the memory 50. The output data generator 18 packages the output image data in an output stream having the same number of frames as that of the input stream, and then outputs the output stream via the network controller 40.

As long as the feature area information and the optimum area information can specify a rectangular area, they can be any kind of information. For example, the feature area information can include a combination of the first feature coordinate and size information showing the size of the feature area in the X direction and Y direction, and the optimum area information can be a combination of the first optimum coordinate and size information of the optimum area.

### First Embodiment

The first embodiment will now be described. The first embodiment is an example of the frame controller 16 which generates output image data corresponding to the feature area of the original image.

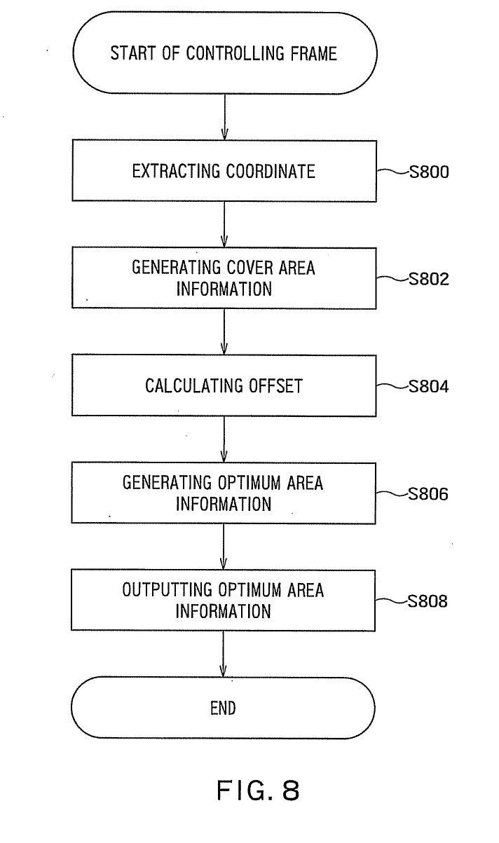

The constitution of the frame controller 16 of the first embodiment will now be described. FIG. 7 is a block diagram of the frame controller 16 of the first embodiment. The frame controller 16 includes a cover area generator 160 and an optimum area generator 162. The cover area generator 160 generates cover area information based on the feature area information. The cover area information is information showing a position on the frame data of a cover area including all of the feature areas. If there is one feature portion, the cover area information is identical to the feature area information. The optimum area generator 162 performs a calculation using the cover area information and predetermined offsets to generate optimum area information.

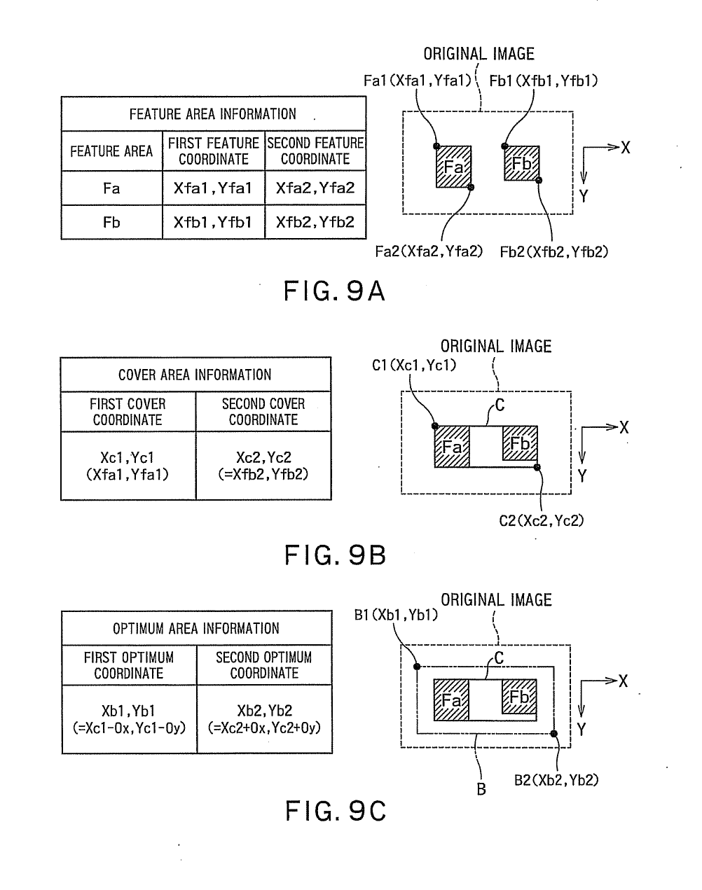

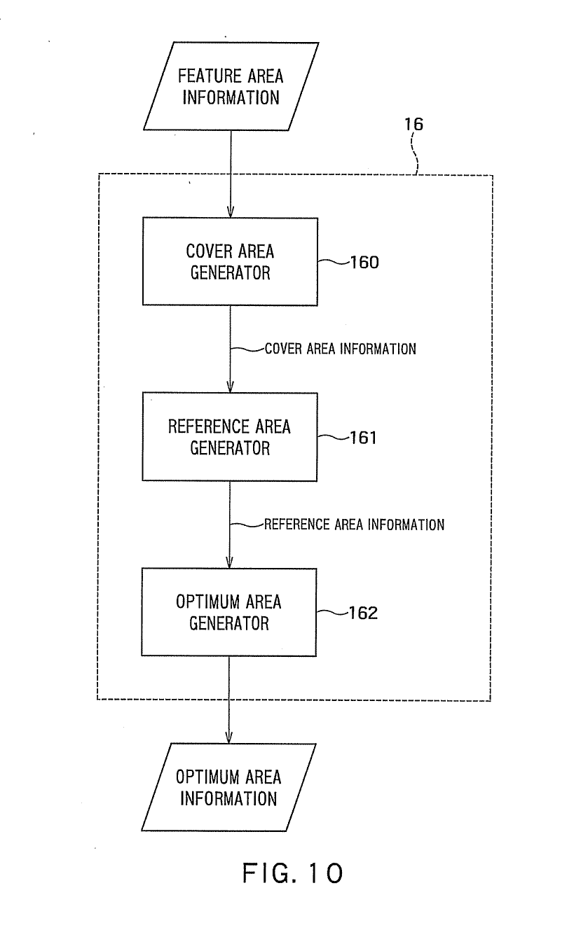

The operation of the frame controller 16 of the first embodiment will now be described. FIG. 8 is a flow chart of the frame control of the first embodiment. FIGS. 9A and 9B show explanatory diagrams of the frame control of the first embodiment. In FIGS. 9A and 9B, the relationship of Xfa1<Xfa2<Xfb1<Xfb2 and Yfa1<Yfb1<Yfb2<Yfa2 is assumed.

<S800> The cover area generator 160 determines the minimum coordinate and the maximum coordinate among all of the coordinates of the feature area information. All of the coordinates of the feature area information means the first and second coordinates specifying the feature areas F. The number of coordinates in the feature area information depends on the number of feature areas F. In the case of FIG. 9A, the minimum coordinate (Xfa1, Yfa1) and the maximum coordinate (Xfb2, Yfa2) are determined among all of the coordinates (Xfa1, Yfa1), (Xfa2, Yfa2), (Xfb1, Yfb1), and (Xfb2, Yfb2) of the feature area information. In this case, since the size of the feature areas Fa and Fb are not uniform, the minimum coordinate coincides with the first feature coordinate (Xfa1, Yfa1), but the maximum coordinate does not coincide with any of the feature coordinates. Incidentally, if the size in the X direction and the Y direction of all of the feature areas is uniform, the minimum coordinate and the maximum coordinate will coincide with one of the feature coordinates.

<S802> The cover area generator 160 determines the minimum coordinate as a first cover coordinate (Xc1, Yc1) of the cover area, determines the maximum coordinate as a second cover coordinate (Xc2, Yc2) of the cover area, and then generates the cover area information. In the case of FIG. 9B, the first cover coordinate (Xc1, Yc1) is the minimum coordinate (Xfa1, Yfa1), and the second cover coordinate (Xc2, Yc2) is the maximum coordinate (Xfb2, Yfa2). The cover area C is a rectangular area defined by the first and second cover coordinates.

<S804> The optimum area generator 162 calculates the size of the optimum area based on the optimum area information, and then calculates the first offset Ox and the second offset Oy based on the size of the optimum area and a predetermined aspect ratio (for example, 16:9). At this time, the optimum area generator 162 calculates the first and second offsets Ox and Oy so that the ratio of the size in the X direction and the Y direction of the optimum area B matches the aspect ratio. The aspect ratio can be an aspect ratio of the display 8, or an arbitrary value provided from outside (for example, a user) of the image processing apparatus 10.

<S806> The optimum area generator 162 performs a calculation by using the cover area information (the first and second cover coordinates) and the first and second offsets Ox and Oy, and then generates the optimum area information. The optimum area information includes the first and second optimum coordinates. In the case of FIG. 9C, the first optimum coordinate (Xb1, Yb1) is (Xc1−Ox, Yc1−Oy), and the second optimum coordinate (Xb2, Yb2) is (Xc2+0x, Yc2+Oy). Thereby, the optimum area B has the aspect ratio. If the ratio of the size in the X direction and the Y direction of the cover area C matches the aspect ratio, the first and second offsets Ox and Oy will be zero.

Incidentally, in the case that the number of the feature area is one, the feature area and the cover area will coincide with each other, and thus the first cover coordinate (Xc1, Yc1) will be the first feature coordinate (Xf1, Yf1) and the second cover coordinate (Xc2, Yc2) will be the second feature coordinate (Xf2, Yf2). In this case, S800 and S802 can be omitted.

<S808> The optimum area generator 162 transmits the optimum area information to the memory 50. Next, the output data generator 18 inputs the sampled frame data among the plurality of pieces of frame data of the input stream, and then generates output image data including the pixels of the optimum area B defined by the optimum area information stored in the memory 50 (S306).

Incidentally, in the first embodiment, the memory 50 can be omitted. In this case, the optimum area generator 162 outputs the optimum area information to the output data generator 18. The output data generator 18 generates output image data based on the optimum area information which has been inputted (S306).

According to the first embodiment, the optimum area information showing the position of the optimum area including the feature portion of the original image is generated, and then image output data is generated based on the optimum area information. Thereby, a user can obtain an output image representing the feature portion without providing an instruction to the image processing apparatus 10.

### Second Embodiment

A second embodiment will now be described. The second embodiment is an example of the frame controller 16 which generates output image data while tracing the movement of the frames. Incidentally, descriptions which are the same as those of the first embodiment will not be repeated.

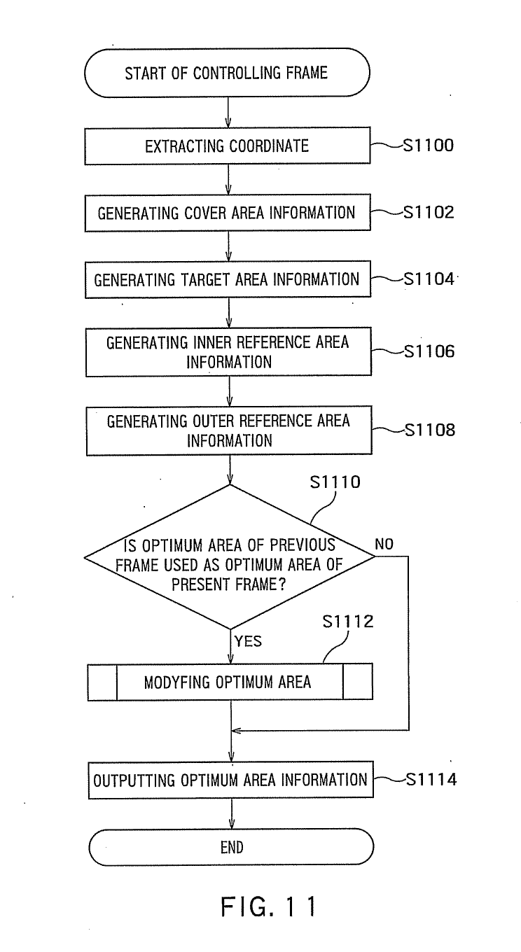

The constitution of the frame controller 16 of the second embodiment will now be described. FIG. 10 is a block diagram of the frame controller 16 of the second embodiment. The frame controller 16 includes a cover area generator 160, a reference area generator 161, and an optimum area generator 162. The cover area generator 160 is the same as that in the first embodiment.

The reference area generator 161 generates reference area information based on the cover area information. The reference area information is information showing conditions of whether to use the optimum area B(n−1) (n is an integer of 1 or more) of the (n−1)th previous frame as the optimum area B(n) of the (n)th present frame.

The optimum area generator 162 determines whether to use the optimum area B(n−1) of the previous frame as the optimum area B(n) of the present frame based on the reference area information. If the optimum area B(n−1) of the previous frame is not used as the optimum area B(n) of the present frame, the optimum area generator 162 changes the optimum area information showing the optimum area B(n−1) of the previous frame into the optimum area information showing the optimum area B(n) of the present frame.

Incidentally, initial optimum area information (for example, the first and second optimum coordinates defining all of the areas of the original image) is stored in advance in the memory 50. Therefore, regarding the first output stream, the optimum area corresponding to the initial optimum area information is the optimum area B(n) of the present frame.

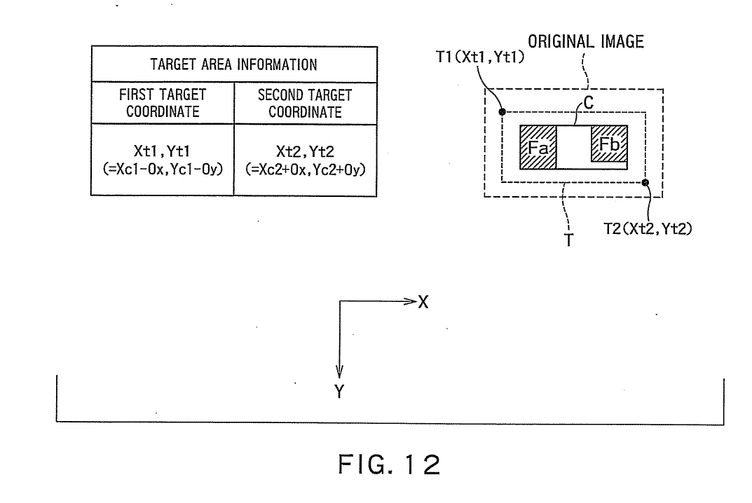

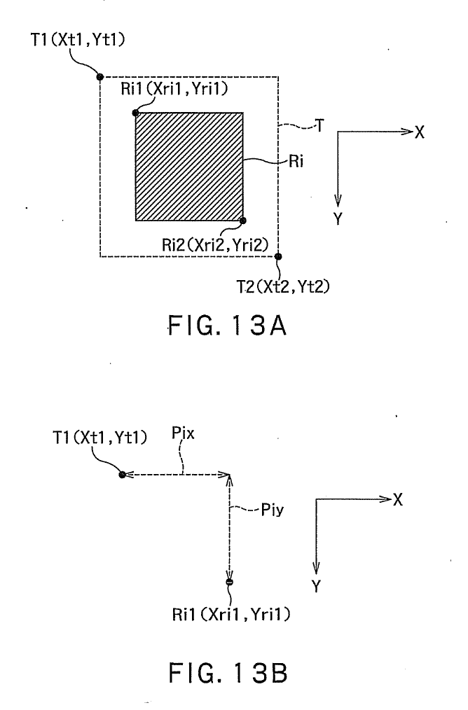

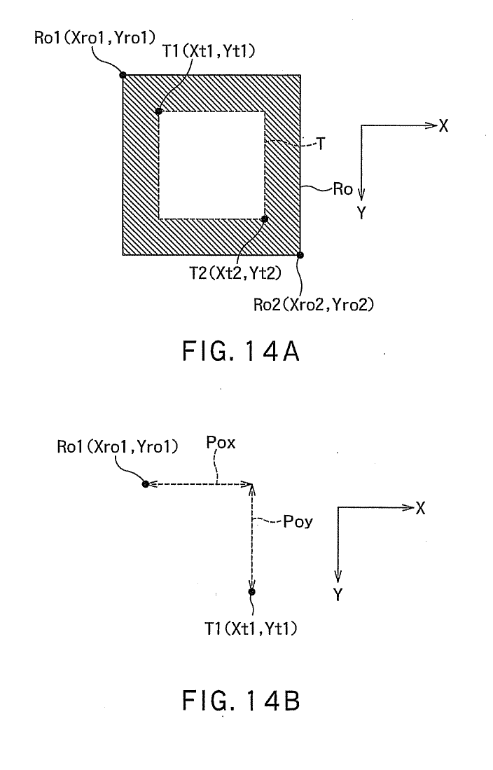

The operation of the frame controller 16 of the second embodiment will now be described. FIG. 11 is a flow chart of the frame control of the second embodiment.

<S1100 to S1102> The cover area generator 160 generates cover area information in the same way as in S800 and S802 of the first embodiment.

<S1104> The reference area generator 161 performs calculation by using the first and second cover coordinates and the first and second offsets Ox and Oy, and then generates target area information. FIG. 12 is an explanatory diagram of the data structure of the target area information of the second embodiment. The target area information includes a first target coordinate (Xt1, Yt1) (=(Xc1−Ox, Yc1−Oy)) and a second target coordinate (Xt2, Yt2) (=(Xc2+Ox, Yc2+Oy)). A target area T is a rectangular area defined by the first target coordinate (Xt1, Yt1) and the second target coordinate (Xt2, Yt2). The target area T means an area to be the base used for generating the reference area information, and it is information that is used for tracing the movement of the frames.

<S1106> The reference area generator 161 generates inner reference area information by using the target area information and inner parameters. FIGS. 13A and 13B are schematic views of the target area T and an inner reference area Ri of the second embodiment. The inner reference area information Ri shows an allowable range that is more inward than the target area T, regarding the optimum area B (see FIG. 13A). The inner parameters include a first inner parameter Pix in the X direction and a second inner parameter Piy in the Y direction (see FIG. 13B). The reference area generator 161 generates a first inner coordinate (Xri1, Yri1) and a second inner coordinate (Xri2, Yri2) based on Equation 1. The inner reference area Ri is a rectangular area defined by the first inner coordinate (Xri1, Yri1) and the second inner coordinate (Xri2, Yri2). The inner reference area information is stored in the memory 50. The inner parameters can be stored in advance in the memory 50, or can be provided from outside of the image processing apparatus 10.

Xri1=Xt1+Pix

Yri1=Yt1+Piy

Xri2=Xt2−Pix

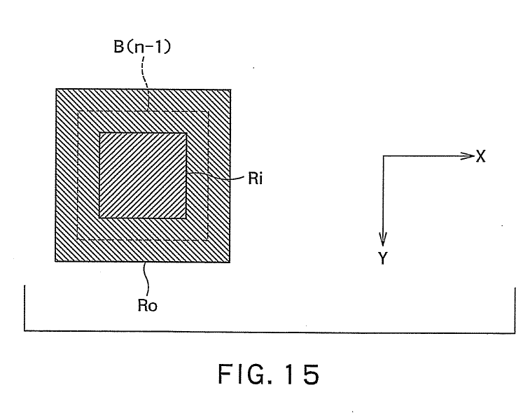

Yri2=Yt2−Piy [Equation 1]

<S1108> The reference area generator 161 generates outer reference area information by using the target area information and outer, parameters. FIGS. 14A and 14B are schematic views of the target area T and an outer reference area Ro of the second embodiment. The outer reference area Ro shows an allowable range that is more outward than the target area T, regarding the optimum area B (see FIG. 14A). The outer parameters include a first outer parameter Pox in the X direction and a second outer parameter Poy in the Y direction (see FIG. 14B). The reference area generator 161 generates a first outer coordinate (Xro1, Yro1) and a second outer coordinate (Xro2, Yro2) based on Equation 2. The outer reference area Ro is a rectangular area defined by the first outer coordinate (Xro1, Yro1) and the second outer coordinate (Xro2, Yro2). The outer reference area information is stored in the memory 50. The outer parameters can be stored in advance in the memory 50, or can be provided from outside of the image processing apparatus 10.

Xro1=Xt1−Pox

Yro1=Yt1−Poy

Xro2=Xt2+Pox

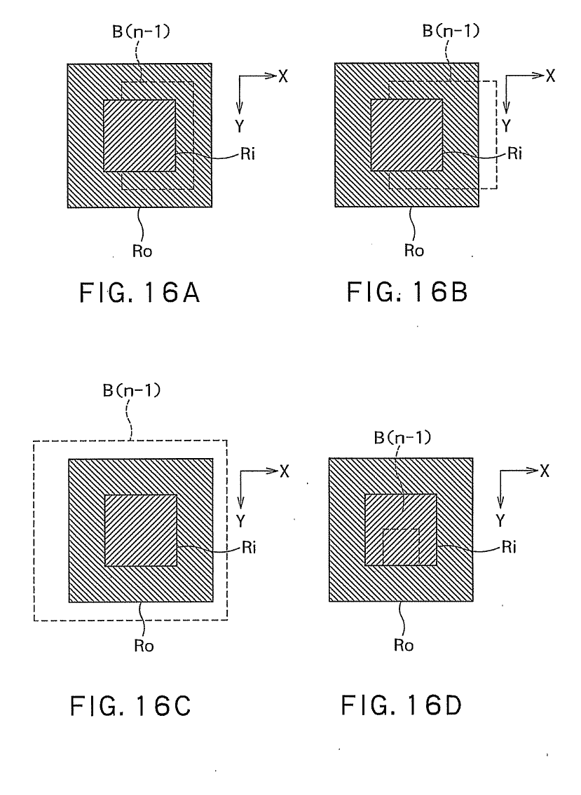

Yro2=Yt2+Poy [Equation 2]

<S1110> The optimum area generator 162 determines whether to use the optimum area B(n−1) of the previous frame as the optimum area B(n) of the present frame based on the positional relationship among three areas (that is, the optimum area B(n−1) of the previous frame, the inner reference area Ri, and the outer reference area Ro). FIGS. 15 and 16A to 16D are explanatory diagrams of the optimum area B of the second embodiment.

In S1110, first and second conditions are used. It is the first condition in which the optimum area B(n−1) of the previous frame includes the entire inner reference area Ri. It is the second condition in which the outer reference area Ro includes the entire optimum area B.

As shown in FIG. 15, if the first and second conditions are met, the optimum area generator 162 uses the optimum area B(n−1) of the previous frame as the optimum area B(n) of the present frame. In other words, if each side of the optimum area B(n−1) of the previous frame is located between an outline of the inner reference area Ri and an outline of the outer reference area Ro, the optimum area generator 162 uses the optimum area B(n−1) of the previous frame as the optimum area B(n) of the present frame. In more detail, if all of the conditions of Equation 3 or 4 are met regarding the first coordinate (Xb(n−1)1, Yb(n−1)1) and the second coordinate (Xb(n−1)2, Yb(n−1)2) of the optimum area B(n−1) of the previous frame, the optimum area generator 162 uses the optimum area B(n−1) of the previous frame as the optimum area B(n) of the present frame. In this case, the operation proceeds to S1114 after S1110.

Xro1<Xb(n−1)1<Xri1

Yro1<Yb(n−1)1<Yri1

Xro2>Xb(n−1)2>Xri2

Yro2>Yb(n−1)2>Yri2 [Equation 3]

Xro1≦Xb(n−1)1≦Xri1

Yro1≦Yb(n−1)1≦Yri1

Xro2≧Xb(n−1)2≧Xri2

Yro2≧Yb(n−1)2≧Yri2 [Equation 4]

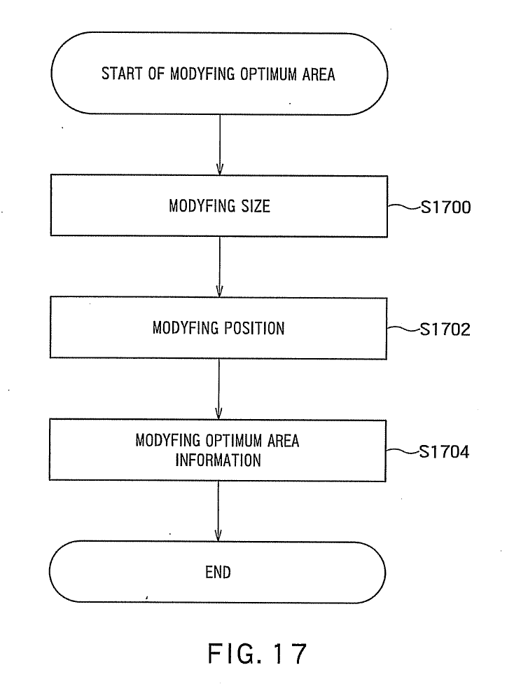

Meanwhile, as shown in FIG. 16, if one of the first condition and the second condition is not met, the optimum area generator 162 makes a determination not to use the optimum area B(n−1) of the previous frame as the optimum area B(n) of the present frame. In more detail, if one of the four conditions of Equation 3 or 4 is not met regarding the first coordinate (Xb(n−1)1, Yb(n−1)1) and the second coordinate (Xb(n−1)2, Yb(n−1)2) of the optimum area B(n−1) of the previous frame, the optimum area generator 162 determines that movement of the optimum area B is necessary. In other words, if the optimum area B is not included in the allowable range defined by the inner reference area Ri and the outer reference area Ro, the optimum area generator 162 determines that movement of the optimum area B is necessary. In this case, the operation proceeds to S1112 after S1110.

<S1112> The optimum area generator 162 modifies the optimum area information in the memory 50. The optimum area B is moved to be near the target area T. FIG. 17 is a flow chart of the optimum area movement of the second embodiment.

<S1700> The optimum area generator 162 calculates a size change amount of the first and second optimum coordinates for modifying the size of the optimum area B by only a predetermined number of pixels (for example, two pixels). The size change amount is information showing a change magnification for making the size of the optimum area B close to the size of the target area T, and it is defined by a predetermined size step amount.

<S1702> The optimum area generator 162 calculates a position change amount of the first and second optimum coordinates for modifying the position of the optimum area B by only a predetermined number of pixels (for example, two pixels). The position change amount is information showing a shift amount for making the position of the optimum area B approach the position of the target area T, and it is defined by a predetermined shift step amount.

<S1704> The optimum area generator 162 modifies the first and second optimum coordinates of the optimum area information stored in the memory 50 based on the size change amount and the position change amount. The modified optimum area information shows the position of the optimum area B′ after movement. In more detail, the optimum area generator 162 modifies the first and second optimum coordinates by using Equations 5 and 6. In Equation 5, Wb(n) is the width of the optimum area of the present frame, Wb(n1) is the width of the optimum area of the previous frame, Zo is a predetermined zoom amount, Hb(n) is the height of the optimum area of the present frame, Hb(n−1) is the height of the optimum area of the previous frame, and AV is the aspect value. For example, in the case of an aspect ratio of 16:9, the aspect value is 16/9. In Equation 6, Hso is the position change amount in the horizontal direction, and Vso is the position change amount in the vertical direction.

Wb(n)=Wb(n−1)+Zo

Hb(n)=Wb(n)/Av [Equation 5]

$$Xb 1 = Xb ( n - 1 ) 1 + \frac{Wb ( n - 1 ) - Wb ( n )}{2} + Hso \\ Yb 1 = Yb ( n - 1 ) 1 + \frac{Hb ( n - 1 ) - Hb ( n )}{2} + Vso \\ Xb 2 = Xb 1 + Wb ( n ) + Hso \\ Yb 2 = Yb 1 + Hb ( n ) + Vso \qquad [ Equation 6 ]$$

<S1114> The optimum area generator 162 outputs the optimum area information stored in the memory 50 to the output data generator 18. For example, the optimum area information stored in the memory 50 immediately before S1114 on the present frame is the optimum area information of the previous frame stored in the memory 50 at the time the frame control for the previous frame was completed (i.e. directly before S1110 on the present frame, that is, the optimum area information shows the position of the optimum area B before movement), or the optimum area information of the present frame as modified in S1704 on the present frame (that is, the optimum area information shows the position of the optimum area B′ after movement).

Next, the output data generator 18 inputs the sampled frame data among the plurality of pieces of frame data of the input stream, and then generates output image data including the pixels of the optimum area B or the optimum area B′ after movement (S306). This optimum area B or optimum area B′ after movement is defined by the first optimum coordinate (Xb1, Yb1) and the second optimum coordinate (Xb2, Yb2) of the optimum area information outputted in S1114.

In the second embodiment, in the case that the movement of the optimum area B is determined to be necessary in S1110, output image data including the pixels of the optimum area B′ after movement defined by the modified first optimum coordinate (Xb1, Yb1) and the modified second optimum coordinate (Xb2, Yb2) is generated. On the other hand, in the case that the movement of the optimum area B is determined to be unnecessary in S1110, output image data including the pixels of the optimum area B(n−1) of the previous frame is generated. According to the second embodiment, since the movement of the frames is traced, if the movement of the feature portion is large, an image which smoothly follows the feature portion can be generated, and if the movement of the feature portion is small, an image like a still image can be generated.

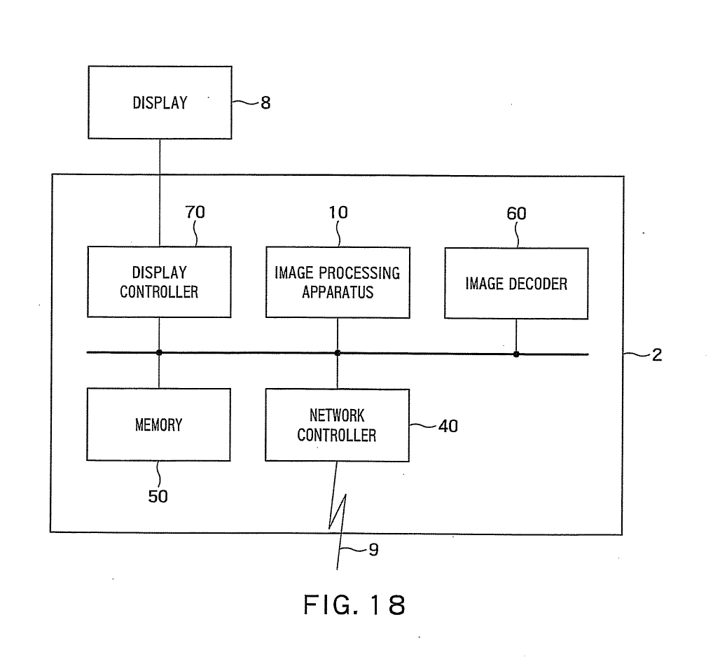

Incidentally, the image processing apparatus 10 of the present embodiment can be provided with not only the image encoding system 1, but also to an image decoding system 2. FIG. 18 is a block diagram of the image decoding system 2 of the present embodiment. The image decoding system 2 is an image processing system including an image processing apparatus 10, a network controller 40, a memory 50, an image decoder 60, and a display controller 70.

The image decoder 60 decodes encoded data, and then generates an input stream. The image processing apparatus 10 generates an output stream based on the input stream generated by the image decoder 60. The display controller 70 generates display image data to be displayed on the display 8 based on the output stream generated by the image processing apparatus 10. An image corresponding to the display image data is displayed on the display 8.

At least a portion of the image encoding system 1 according to the above-described embodiments may be composed of hardware or software. When at least a portion of the image encoding system 1 is composed of software, a program for executing at least some functions of the image encoding system 1 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the image encoding system 1 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing apparatus comprising:
a feature based detector configured to detect a feature portion of input image data and generate feature area information showing a position of a feature area comprising the detected feature portion;
an optimum area generator configured to generate optimum area information showing a position of an optimum area in accordance with a size of the feature area based on the feature area information; and
an output data generator configured to extract pixels of the optimum area among the input image data based on the optimum area information and to generate output image data based on the extracted pixels.

2. The apparatus of claim 1, further comprising a cover area generator configured to generate cover area information showing a position of a cover area comprising a plurality of feature portions based on the feature area information,
wherein the optimum area generator performs calculation by using the cover area information and offsets, and generates the optimum area information.

3. The apparatus of claim 1, further comprising:
a memory configured to store the optimum area information; and
a reference area generator configured to determine whether an optimum area of a previous frame is used as an optimum area of a present frame,
wherein, when the optimum area of the previous frame is not used as the optimum area of the present frame, the optimum area generator modifies the optimum area information stored in the memory to optimum area information showing the optimum area of the present frame, and
the output data generator outputs the output image data based on the optimum area information stored in the memory.

4. The apparatus of claim 3, wherein the reference area generator
generates target area information showing a position of a target area having an aspect ratio in the feature area information,
generates inner reference area information showing a position of an inner reference area by using the target area information and inner parameters,
generates outer reference area information showing a position of an outer reference area by using the target area information and outer parameters, and
determines whether it is necessary to move the optimum area based on a positional relationship among the optimum area, the inner reference area and the outer reference area.

5. The apparatus of claim 4, wherein when one of a first condition in which the optimum area comprises the entirety of the inner reference area and a second condition in which the outer reference area comprises the entirety of the optimum area is not met, the reference area generator determines that the optimum area of the previous frame is not used as the optimum area of the present frame.

6. The apparatus of claim 5, wherein when it is determined that the optimum area of the previous frame is not used as the optimum area of the present frame, the optimum area generator modifies the optimum area information stored in the memory.

7. The apparatus of claim 6, wherein the optimum area generator calculates a size change amount of a size of the optimum area and a position change amount of a position of the optimum area, and modifies the optimum area information stored in the memory based on the size change amount and the position change amount.

8. An image encoding system comprising:
an image generator configured to generate input image data;
a feature based detector configured to detect a feature portion of the input image data and generate feature area information showing a position of a feature area comprising the detected feature portion;
an optimum area generator configured to generate optimum area information showing a position of an optimum area in accordance with a size of the feature area based on the feature area information; and
an output data generator configured to extract pixels of the optimum area among the input image data based on the optimum area information and to generate output image data based on the extracted pixels.

9. The system of claim 8, further comprising a cover area generator configured to generate cover area information showing a position of a cover area comprising a plurality of feature portions based on the feature area information,
wherein the optimum area generator performs calculation by using the cover area information and offsets, and generates the optimum area information.

10. The system of claim 8, further comprising:
a memory configured to store the optimum area information; and
a reference area generator configured to determine whether an optimum area of a previous frame is used as an optimum area of a present frame,
wherein, when the optimum area of the previous frame is not used as the optimum area of the present frame, the optimum area generator modifies the optimum area information stored in the memory to optimum area information showing the optimum area of the present frame, and
the output data generator outputs the output image data based on the optimum area information stored in the memory.

11. The system of claim 10, wherein the reference area generator
generates target area information showing a position of a target area having an aspect ratio in the feature area information,
generates inner reference area information showing a position of an inner reference area by using the target area information and inner parameters,
generates outer reference area information showing a position of an outer reference area by using the target area information and outer parameters, and
determines whether it is necessary to move the optimum area based on a positional relationship among the optimum area, the inner reference area and the outer reference area.

12. The system of claim 11, wherein when one of a first condition in which the optimum area comprises the entirety of the inner reference area and a second condition in which the outer reference area comprises the entirety of the optimum area is not met, the reference area generator determines that the optimum area of the previous frame is not used as the optimum area of the present frame.

13. The system of claim 12, wherein when it is determined that the optimum area of the previous frame is not used as the optimum area of the present frame, the optimum area generator modifies the optimum area information stored in the memory.

14. The system of claim 13, wherein the optimum area generator calculates a size change amount of a size of the optimum area and a position change amount of a position of the optimum area, and modifies the optimum area information stored in the memory based on the size change amount and the position change amount.

15. An image decoding system comprising:
an image decoder configured to decode encoded data and generate input image data;
a feature based detector configured to detect a feature portion of the input image data and generate feature area information showing a position of a feature area comprising the detected feature portion;
an optimum area generator configured to generate optimum area information showing a position of an optimum area in accordance with a size of the feature area based on the feature area information;
an output data generator configured to extract pixels of the optimum area among the input image data based on the optimum area information and to generate output image data based on the extracted pixels; and
a display controller configured to generate display image data to be displayed on the basis of the output image data.

16. The system of claim 15, further comprising a cover area generator configured to generate cover area information showing a position of a cover area comprising a plurality of feature portions based on the feature area information,
wherein the optimum area generator performs calculation by using the cover area information and offsets, and generates the optimum area information.

17. The system of claim 15, further comprising:
a memory configured to store the optimum area information; and
a reference area generator configured to determine whether an optimum area of a previous frame is used as an optimum area of a present frame,
wherein, when the optimum area of the previous frame is not used as the optimum area of the present frame, the optimum area generator modifies the optimum area information stored in the memory to optimum area information showing the optimum area of the present frame, and
the output data generator outputs the output image data based on the optimum area information stored in the memory.

18. The system of claim 17, wherein the reference area generator
generates target area information showing a position of a target area having an aspect ratio in the feature area information,
generates inner reference area information showing a position of an inner reference area by using the target area information and inner parameters,
generates outer reference area information showing a position of an outer reference area by using the target area information and outer parameters, and
determines whether it is necessary to move the optimum area based on a positional relationship among the optimum area, the inner reference area and the outer reference area.

19. The system of claim 18, wherein when one of a first condition in which the optimum area comprises the entirety of the inner reference area and a second condition in which the outer reference area comprises the entirety of the optimum area is not met, the reference area generator determines that the optimum area of the previous frame is not used as the optimum area of the present frame.

20. The system of claim 19, wherein when it is determined that the optimum area of the previous frame is not used as the optimum area of the present frame, the optimum area generator modifies the optimum area information stored in the memory.
